(19) United States
(12) Patent Application Publication
(10) Pub. No.: US 2008/0254434 A1
(43) Pub. Date: Oct. 16, 2008

(54) Learning management system

(76) Inventor: Nathan Calvert, Austin, TX (US)

Correspondence Address: Nathan Calvert, 1211 W 8th, No. 201, Austin, TX, 78703, US

(21) Appl. No.: 12/101,984

(22) Filed: Apr. 12, 2008

Related U.S. Application Data
(60) Provisional application No. 60/911,558, filed on Apr. 13, 2007.

(51) Int. Cl. G09B 7/00; G09B 5/08

(52) U.S. Cl. 434/350; 709/204

(57) ABSTRACT

Learning management systems and methods are provided with improvements allowing meta-tagging of learning objects with specific characteristics. An intelligent tutor application may employ the tags in search and tutorial scenarios. In some embodiments, an intelligent tutor application is programmed for selecting and providing learning objects for presentation to a participant through the participant client application, the intelligent tutor application including a software interface adapter for sending software interface function commands associated with the conformant learning object on behalf of the participant, the intelligent tutor application further including a search and selection software module, a learning style analysis software module, and a tutoring engine software module. In some embodiments, an intelligent tutor interacts with a SCORM-compliant LMS through a modified API adapater.

### CROSS REFERENCE TO RELATED APPLICATIONS

This application claims priority under 35 USC Section 119 to Provisional Application No. 60/911558, filed Apr. 13, 2007, which is hereby incorporated by reference for all purposes.

### TECHNICAL FIELD

This invention relates to learning management systems, particularly for systems including delivery of learning objects identified by meta tags and use of an intelligent tutor application with the learning management system.

### BACKGROUND

A Learning Management System (or LMS) is a software package that enables the management and delivery of electronic material to learners. Typically an LMS allows for registration, delivery of learning activities or learning “objects”, and assessment online. More comprehensive LMSs often include tools such as competency management, skills-gap analysis and educational sequence planning and certifications. SCORM, or Sharable Content Object Reference Model, is a collection of standards and specifications for e-learning. CLCIMS (Computer Learning Content Information Management System), is often used in the e-learning sector to define a SCORM-compliant learning environment, which may cover a broad variety of LMS systems.

LMSs run on a variety of platforms, from PHP/MySQL based architectures to Microsoft NET, and typically employ a database back-end. In addition to managing the administrative functions of online learning, some systems also provide tools to deliver instructor-led synchronous and asynchronous online training. These LMS variants are sometimes called Learning Content Management Systems (LCMSs). An LCMS may provide tools for authoring content as well as discussion forums or chat-rooms for instructor/learner interaction.

An LMS often replaces isolated e-learning programs with a systematic means of delivering e-learning material and assessing learner progress. An LMS may also organize certification efforts, enabling companies to manage strategic learning goals and achieve corporate skills management. In contrast, the term LCMS is often employed to describe an LMS more focused on learning content. Such a system gives instructional designers, teachers, and subject matter experts tools to create e-learning content.

Typical characteristics shared by both types of LMSs include managing users, roles, courses, instructors, and facilities and generate reports; learner notices and messaging; assessment; grading; and, of course, web-based or network-based course delivery, which may be blended with live course delivery. Frequently missing, however, are schemes to provide a computer-managed learning sequence such as, for example, a tutoring application. Also missing are schemes to identify learning objects in a way tutoring applications can locate and employ them.

What is needed is LMS systems that can provide tutoring applications that work within typical LMS frameworks such as a SCORM-compliant LMS. What is further needed are schemes to identify learning objects in such a way that they can be located and utilized by a tutoring application.

### SUMMARY

Learning management systems are provided with improvements allowing meta-tagging of learning objects with specific characteristics. An intelligent tutor application may employ the tags in search and tutorial scenarios. In one embodiment, a learning management system server hosts a software interface exposing functions to process learning activities associated with conformant learning objects presented at a participant client application having a first software interface adapter. An intelligent tutor application is programmed for selecting and providing learning objects for presentation to a participant through the participant client application, the intelligent tutor application including a second software interface adapter for sending software interface function commands associated with the conformant learning object on behalf of the participant, the intelligent tutor application further including a search and selection software module, a learning style analysis software module, and a tutoring engine software module.

In another embodiment, a learning management system includes a server hosting a software interface exposing functions to process learning activities associated with conformant learning objects presented at a participant client application having a first software interface adapter. The system further includes an intelligent tutor application, running on the learning management system server, for selecting and providing learning objects for presentation to a participant through the participant client application, the intelligent tutor application further comprising a search and selection software module operable to search a first local learning object repository and at least a second remote learning object repository.

In various implementations, such systems may include an interface to local databases holding a first set of learning objects. They may also include an interface to at least one remote database holding a second set of learning objects. The LMS system may further include a learner profile service software module for tracking a learners preferred and non-preferred learning styles. Still further, certain embodiments may be made wherein the software interface on the learning management system server is an API capable of interfacing with the first software interface adapter and second software interface adapters, which are both API adapters. The API may be a SCORM API. In some embodiments, the first software interface adapter may be a SCORM API adapter, and the second software interface adapter may be an augmented SCORM API adapter.

In other variations, the LMS server further includes an identifier key for a subscription to the second remote learning object repository. The intelligent tutor application may be programmed to minimize cost of providing a suitable learning object needed for provision to a participant by first selecting local repository learning objects, and lacking those selecting flat rate subscription learning objects, and lacking those selecting pay-per-use learning objects. The search and selection software module is operable to search meta-tags associated with learning objects. The meta-tags may provide at least one indication of learning style characteristics of their associated learning objects. The meta-tags may provide an indication of a primary learning style and a secondary learning style associated with a single learning object.

Still other embodiments provide methods of presenting computer-assisted tutoring sessions including searching, by a tutor application, for a first learning object having a first subject characteristic and a first preferred learning style characteristic and then presenting the first learning object to a student having a profile indicating the first preferred learning style characteristic. The method may include further assessing the student's facility for working with a second learning style with material taught from the first learning object. The second learning style may be a non-preferred learning style indicated in the student's profile.

The method may further include searching, by the tutor application, for a second learning object having a third blended learning style of the second learning style and the first learning style. The method may present the second learning object to the student, the second learning object including a material in the first preferred learning style and the second non-preferred learning style. The second learning object may have associated meta tags indicating a mixed learning style of the first preferred learning style and the second non-preferred learning style. The first learning object may have an associated meta-tag indicating a primary learning style, and the tutor applications searching process includes searching for a matching meta-tag.

Still other methods and systems may include routines for monitoring and adjusting a students emotional state to help ensure optimal learning states.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an architectural diagram of a learning management system (LMS) according to one embodiment.

FIG. 2 is a block diagram of an LMS according to another embodiment.

FIG. 3 is a flow chart of an alert scheme according to one embodiment.

FIG. 4 is a detailed block diagram of portions of an LMS according to another embodiment.

FIG. 5 is a flow chart of one tutoring method for an intelligent tutor application according to one embodiment.

FIG. 6 is a flow chart of a learning object access method according to one embodiment.

FIG. 7 is a flow chart of a learning state adjustment method according to one embodiment.

### DETAILED DESCRIPTION

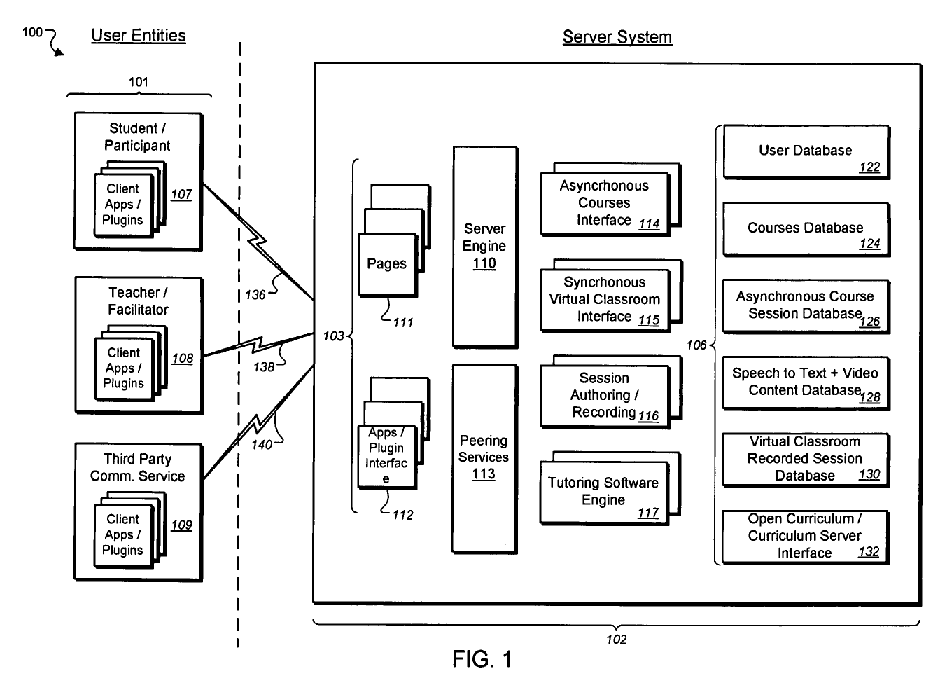

FIG. 1 is an architectural diagram representation of a learning management system 100 they can be used to deliver educational content in a synchronous or asynchronous manner. Learning management system 100 may also be referred to as a course management system, or a virtual learning environment or learning platform according to different terminology or applications. The depicted system 100 includes a server system 102 for hosting and delivering educational content to the user entities 101. In general, the various users such as students, teachers or third party to medication services will access server system 102 over Internet links 136, 138, and 140. A local area network or a combination of networks, both wired and wireless, may also be used.

Referring to user entities 101, users of system 100 may be students or participants 107 in a particular course or educational experience. Also using system 100, in some embodiments, is a teacher or facilitator 108. Each of students 107 were teachers 108 typically work on the system with a client computer having client applications or plug-ins designed to interact with server 12. The client applications may be standalone applications presenting a visual learning interface, or maybe a plug-in for a web browser or other software such as, for example, learning object composition software.

In this embodiment, server system 102 provides learning content to users 101 through a Web server engine 110, which presents webpages 111 in order to present educational material to the users 101. Server system 102 also includes an application/plug-in interface for communicating content and control data to and from the various client applications or plug-ins which may not communicate through typical webpage request responses and commands. Pages 111 and applications interfaces 112 makeup, in this embodiment, one interface to server system 102. Another interface to server system 102 is the curriculum server interface 132 depicted in the lower right. This interface may request formatted educational material, such as for example, learning objects authored in various standard formats, over an Internet or other network link. Such functionality will be further described below.

The preferred embodiment, server engine 110 is an Apache Web server, running PHP and MySQL to provide the various web interface and database capability. Other architectures may be used. For example the Microsoft NET application service provider model may be used, or Java EE, and other databases such as Oracle databases or other SQL databases may be. Also running on server 102 in this embodiment is a peering services host 113. Peering services 113 are employed to set up and manage peer-to-peer communication streams between the various system users. For example peering services 113 may set up a video stream broadcast or an application sharing screen from a teacher 108 to a group of students 107. In other embodiments, such functionality may not be peer-to-peer to communications, but may instead be transmitted through server system 102. In the depicted embodiment, peering services are used to minimize delay and server load.

Server system 102 further includes an asynchronous courses interface module 114. In one preferred embodiment, module 114 is constructed with PHP or other languages providing similar interface functionality. Asynchronous courses interface module 114 provides access to course material in an asynchronous format. Such format date may be characterized in that it does not require the synchronous presence of the teacher or tutor, but it is self directed at the students own pace and timing. Courses interface 114 typically present a class or course, which may include one or more lessons, each including one or more learning objects. A learning object, in this context, is any grouping of materials structured in a meaningful way and tied to an educational objective. For example, courses interface 114 may provide access to a third-grade history course (stored in courses database 124). Portions of such a course may be presented through courses interface 114 student upon request. For example, if a lesson covers the discovery of America, the course may present a learning object such as a video dramatization of the voyage of Columbus (or Leif Eiriksson). Typical course material may include one or more of the following: textbook or less a material, homework assignments, projects, quizzes, tests, rubrics, answer keys, and any appropriate teacher guidance or prerequisite structure. Course material may also include discussion forums and other collaborative or inter-active media such as wiki's or recordings of sessions from synchronous lessons presented by a teacher or facilitator 108 to one or students in 107. Course, lesson, and learning object content and format will be further described below.

Asynchronous courses interface 114 may also present SCORM (Sharable Courseware/Content Object Reference Model) API to provide interactive learning functionality to students through SCORM learning objects which may be stored in the various course databases.

In addition to asynchronous courses interface 114, server system 102 in this embodiment also includes a synchronous course interface module 115, which may also be known as a virtual classroom interface. Other embodiments may include only one of these two interfaces. Synchronous module 115 provides synchronous access to course material stored from various databases and interfaces 106. By synchronous, in this context, it is meant that a teacher or facilitator 108 is logged in simultaneously or synchronously with one or more students 107 and presents lesson material in cooperation with server system 102. For example, a teacher 108 may operate upon application providing a virtual classroom interface having a shared white board area, a shared presentation area, and a student management and chat or audio or video communications means. In such a scenario, the teacher 108 may operate the interface to select and presents various learning objects from the databases 106. The students 107 may see and follow along in a guided synchronous view similar to that seen by teacher 108. The virtual classroom interface may also include such features as application sharing, white board sharing, bandwidth management, session recording, and peering capability for example is described herein. This is not limiting and other features known in the art of e-learning or virtual classroom interfaces may be employed in combination with the systems or techniques described herein.

Referring still to FIG. 1, server system 102 also includes session authoring and recording module 116. In the depicted system, session module 116 receives commands typically from a teacher or facilitator to record ongoing content from the virtual classroom interface 115. Session module 116 may also present an editing interface in which facilitators 108 may construct an asynchronous course session without recording a live session occurring on the system. In preferred embodiment such an asynchronous course session may be stored as a learning object or a lesson in a particular course. Session authoring and recording will be further described below.

Server system 102 also includes tutoring software engine in 117, which, in this embodiment, includes an intelligent software agent designed to guide and tutor a student through a learning object, lesson, or an entire course and series of courses. Tutoring software engine 117 may interact with asynchronous courses interface number 114 to receive input from participating students, make decisions based on that input, and then direct asynchronous courses interface number 114 present certain material in response to a chosen educational strategy. Tutoring software engine 117, in a preferred embodiment, employs and maintains a student profile including data regarding student skill level, learning history, and a profile of the students capabilities with regard to various learning styles. Tutoring software engines will be further described below.

While the depicted system 100 shows students 107 in teachers 108 to be operating different machines which may be at different locations, this is not limiting and a teacher and student may access the system from the same machine at the same time in various learning scenarios. For example, one common user of such a system 100 a parent of a young child who cannot operate all the features of system 100, or cannot read or follow other instructions as to how to proceed through an asynchronous course lesson, for example. In such a case, the parent may sit with the student and guide them through the course content, operating some or all of the interactive features system 100.

Server system 102 generally hosts the learning management system 100 for creating, managing, and delivering educational material. The server system 102 comprises one or more computers operable to receive, transmit, process and store data associated with the architecture 100. Although FIG. 1 illustrates one server system 102 that may be used with the disclosure, the architecture 100 may be implemented using computers other than servers, as well as a server pool. The server system 102 may be any computer or processing device, such as, for example, a blade server, general-purpose personal computer (PC), Macintosh, workstation, Unix-based computer, or any other suitable devices. According to one implementation, the server system 102 may also include or be communicably coupled with a server engine 112 and/or a mail server. As shown in FIG. 1, the server system 102 includes the server engine 112 for serving web pages to client devices across the Internet or other computer network. The server engine 112 generally hosts web pages 111, which can also be associated with scripts, programs, and multimedia files. The server engine 110 can serve the web pages 111 using a protocol such as HTTP (Hypertext Transfer Protocol), or other applicable protocols. A preferred embodiment, similar to many commercial web sites, employs hypertext preprocessor (PHP), which generally runs on the web server taking PHP code as its input and creating Web pages as output. PHP may also be used for command-line scripting or other server-side scripting. Preferably an Apache web server is used with an SQL database install, for example, the popular MySQL, providing the database capability. Other server architectures may be used, for example a Microsoft .NET or a Java EE architecture or a proprietary service architecture run on a network such as a cellular phone network.

Referring to the depicted databases/tables 106 on the right-hand side of FIG. 1, server system 102 includes several databases that may be may be tables or separate databases, or in some instances may be combined within a table. Therefore, while a “database” is described with regard to FIG. 1, various data structures and tables may be used. Databases may also store links to files stored in a file system, or learning objects in the database. Links may be made to learning objects, lessons, or courses, that may be retrieved from other server systems, even systems not associated with the operator of server system 102.

The user database or table 122 can store user accounts as well as user preferences and profiles such as learning style profiles, and academic records. Courses database 124 stores a record of each course offered on system 102. A course typically includes one or more lessons, which may be stored as text on pages, or may include other multimedia and interactive formats. Courses may include links to asynchronous course sessions stored in database 126. Courses may also include links to multimedia content or recordings may be stored in databases 128 and 130. Further, some courses may include links to educational material such as learning objects provided on the Internet or other network by third-party vendors. In one implementation, such links may be made with a direct link to a pre-designated learning object. In other implementations, such a link may be made with an abstract request to a curriculum server or learning server that may search for a matching learning object and provide it back in response to the request. Such requests may be managed by an open curriculum/curriculum server interface 132. For example, tutoring software engine 117 may be directing learning content to a particular student on a topic with which the student has difficulty. Engine 117 may request from curriculum server interface 132 a learning object such as a question drill or a video, the request containing a preferred learning style for the particular student such as, for example, a visual learning style.

The server system 102 may often include local electronic storage capacity, such as data repositories. The data repositories may include any memory or database module and may take the form of volatile or non-volatile memory including, without limitation, magnetic media, optical media, random access memory (RAM), read-only memory (ROM), removable media, or any other suitable local or remote memory component. The illustrated database(s) 106 may store system data such as message data, alert data, VPN applications or services, firewall policies, a security or access log, print or other reporting files, HTML files or templates, data classes or object interfaces, unillustrated software applications or sub-systems, and others.

In the depicted system 100, the server 102 can utilize a restricted computer network, such as a private network created using World Wide Web software, or a public network, such as the Internet. Regardless of the type of computer network utilized, the network (represented abstractly by 136, 138, and 140) facilitates wireless or wireline communication between the server system 102 and users 101. In a preferred embodiment, the network is the internet. The network may also be all or a portion of an enterprise or secured network. In another example, the network may be a virtual private network (VPN) between the users 101 and the server system 102 across a wireline or a wireless link. In certain implementations, the network may be a secure network associated with the enterprise and certain local or remote clients.

Regardless of the particular hardware or software architecture used, the learning management system 100, in this embodiment, can be used to create, manage, and provide learning material and experiences. The following descriptions of methods and screen shots focus on the operation of the LMS 100, or one of its components or sub-modules, in performing one of the respective methods or processes. However, the architecture 100 contemplates using any appropriate combination and arrangement of logical elements implementing some or all of the described functionality.

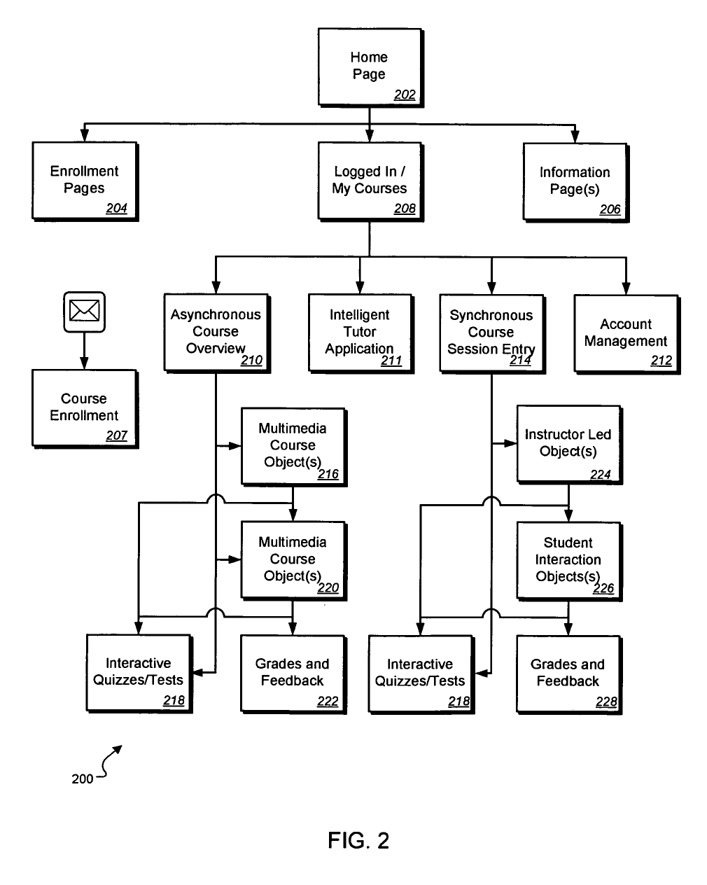

FIG. 2 is a block diagram representation of a LMS website 200 according to one embodiment. The depicted LMS block diagram 200 illustrates a general flow of tasks and selected links in one learning system website. A user begins interacting with the website on the home page 202. From the home page 202, the user or contact can choose to visit enrollment pages 204 for particular courses. The user or contact can additionally choose to visit one or more information pages 206 from the home page 202. The information pages can include details such as how to use the LMS 200, or availability and pricing of courses.

Students may register or enroll for courses at enrollment pages 204, which may include payment options such as credit cards or paypal, for example. Course enrollment may also be accomplished through enrollment emails sent to students providing a link to enrollment page 207 along with other information, such as an enrollment key.

In this embodiment users of system 200 are presented with a view of their currently active courses at page 208. The depicted site design presents two options for students to view and interact with course material. The asynchronous course interaction begins at page 210 which presents an outline of asynchronously presented material available in a particular selected course. By contrast, system 200 presents synchronous course material (led by a facilitator) in synchronous sessions entered through page 214.

After browsing to an asynchronous course entry point 210, a student may select multimedia course objects 216 to view, listen to, or activate or interact with in various ways. Multiple sequential course objects such as the depicted objects 216 and 220 may be selected by the student, or presented in a preset linear order. Multimedia course objects (or “learning objects”) may contain or be interspersed with interactive quizzes or tests 218. Preferably, after completing a session of asynchronous course material, a student is presented with grades or feedback at page 222.

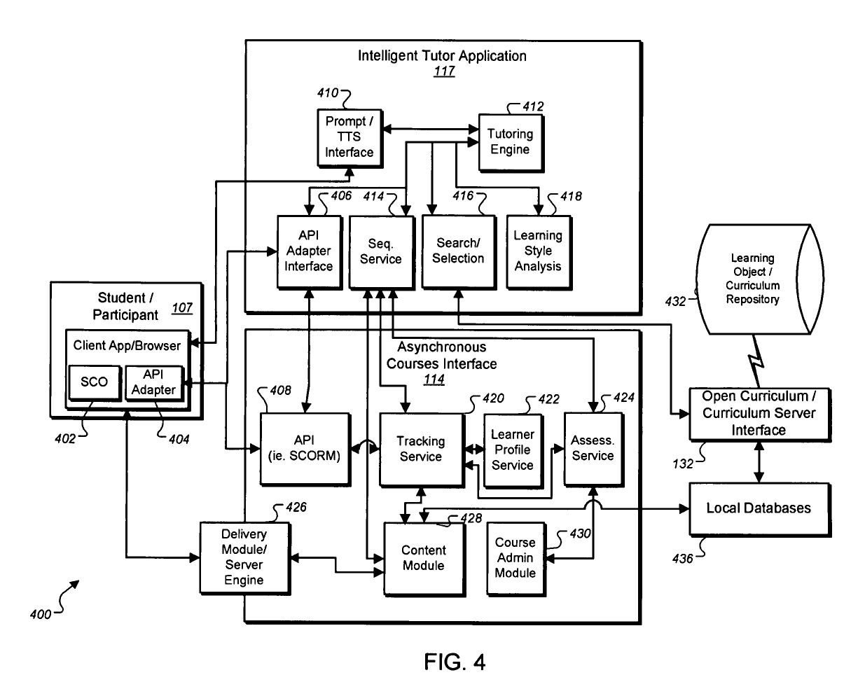

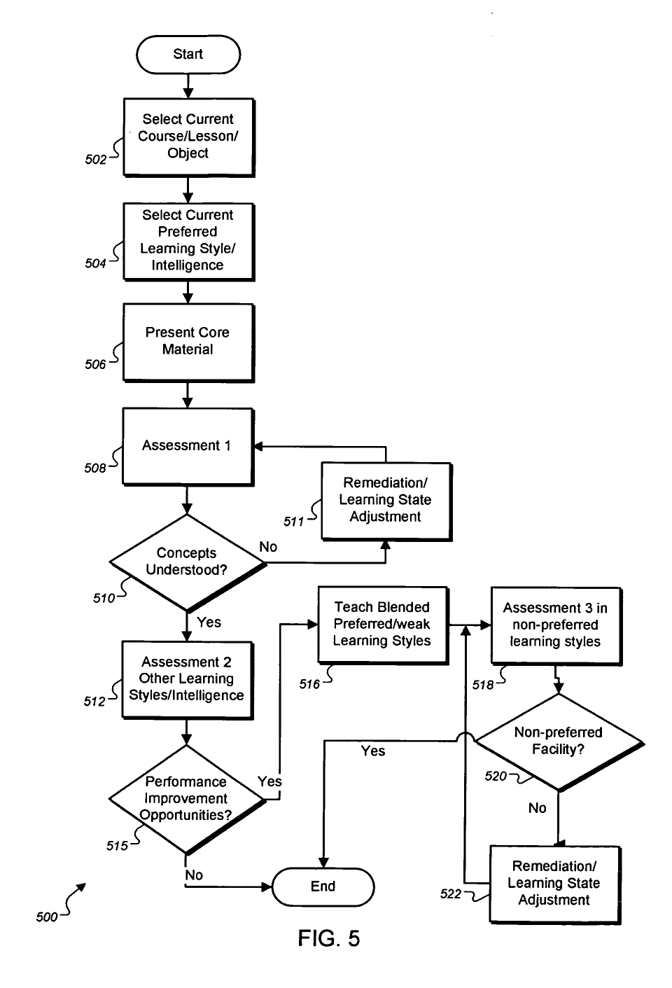

System 200 also includes an intelligent tutor application that may be launched to guide a student through certain course material. Various embodiments of such an application will be further described below, such as with respect to FIG. 4 and FIG. 5. Tutor application 211 is, in this embodiment, a server-side application interfacing with students through web pages. A tutor application may be considered as asynchronous learning material because students typically access it at their own pace, but in some cases tutor-application controlled lessons may have portions that are timed or scheduled and sequenced by the tutor application. Herein we will consider a synchronous learning experience to be one a collaborative effort between a student and other students/teachers.

Regarding the entry point 214 for synchronous course material and sessions, and logged in student will typically be presented with a link to open an eminent scheduled course session. Such a session will typically be led by a teacher, but may be led by another in a facilitator role such as, for example, another student or a third-party guest. In the depicted embodiment, a student clicks on the link on page 214, which activates asynchronous course session. Such a session will typically include, for example, material presented on a slide show or interactive white board by an instructor. This would be known as an instructor led learning object 224. A single synchronous course session may present one or more lessons each including one or more structure led learning objects 224 and 226, which may be interspersed with interactive quizzes or tests 218 presented to the students. Again, a preferred system presents grades or feedback at page 228 to students at the end of each session. The depicted blocks merely represent, we include features in one preferred system 200. Other links and options are possible.

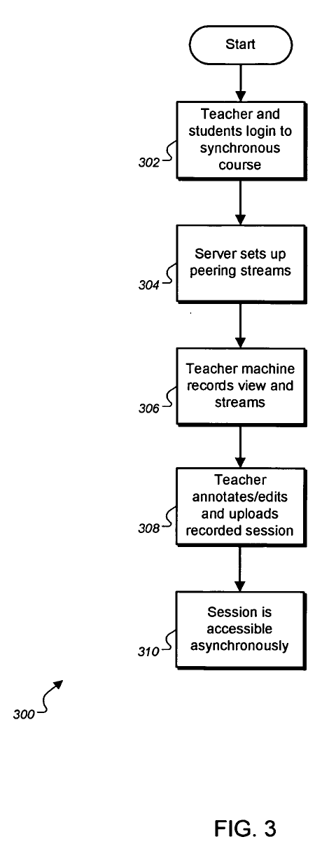

FIG. 3 is a flow chart of an synchronous session recording scheme 300 according to one embodiment. The synchronous session recording scheme 300 can be performed as a sequence of events by a user in combination with LMS 100, for example. The depicted method starts with step 302 when the teacher and students login to the LMS 100 and activate asynchronous course session, for example, by clicking a link at entry point 214 (FIG. 2). In this embodiment, the LMS server system next sets up peering streams to stream voice, application sharing, presentation, or video, for example, between the teacher and students (step 304). In the depicted method the teacher's machine records a view of the active interface at the teacher's machine, and the content of the various streams from this particular synchronous session (step 306). In other embodiments, no recording may take place, or recording may be implemented at the system server. In step 308, a teacher may edit or annotate recorded material. Such editing may include, for example, correcting speech to text narrative associated with the record session, or, as another example, removing unwanted content from the session or adding reference material or more detailed answers to student questions made during or after the session. Teacher editing may also include addition of metatags. Editing at this step may also be performed by technical personnel to insure compliance with a particular e-learning format such as SCORM, for example. In one preferred embodiment, recorded sessions are saved as SCORM learning objects, or SCO's (Sharable Content Objects). A single session and accompanying material may be packaged as assets in a single SCO, or a single SCO may include multiple sessions. This is merely an example in session materially be edited in many different ways. Next in step 308 teacher uploads the record session to the server for entry in the course materials or reuse in other courses as an asynchronous learning object, for example. Sessions may be saved, for example, in virtual classroom recorded session database 130, or database 124 or 126 (FIG. 1). At step 310, the record is session is accessible asynchronously be viewed by students at their leisure from LMS 100.

FIG. 4 is a detailed block diagram of portions of one embodiment of a learning management system 100. In this embodiment a student or participant 107 runs client applications including a browser capable of browsing learning object content 402 (shareable content object “SCO” 402). Also running at the participant machine 107 is an API adapter 404. In one embodiment, API adapter 404 is a JavaScript object residing in the opener window or a parent frame of the window that contains the learning object content. The API adapter handles communications between the learning object content and the LMS server system 102 (FIG. 1). Such an arrangement is used for example in the popular SCORM content aggregation model and run-time environment, which has a score of API 408 running on the LMS.

Running on server system 102 is intelligent tutor application 117 which may feed or push commands to the student machine 107 API adapter 404 through API adapter interface module 406. Alternately, student API adapter 404 may communicate with the API through intelligent tutor's API adapter interface 406. In this manner API adapter 406 may receive input from a student such as for example clicking on links or interactive buttons inside a learning object, or entering answers to questions and some of the learning object. API adapter 404 and the API may also receive commands from the intelligent tutor application 117 (FIG. 1) and send back application data mirroring that sent the student. Such connectivity allows intelligent tutor application 117 to intervene and make browsing selections or start new learning objects on behalf of student/participant 107, even in cases the version of the SCORM API (or other appropriate communications interface) is not designed to accept input from a tutoring application. The tutoring application 117 may present itself to the API 408 as an instance of the learning object, and thereby mediate selections and other input/output to and from the student. At the same, intelligent tutor application 117 and may present itself to the rest of the LMS as an entity having teacher-type privileges.

In this embodiment, intelligent tutor application 117 includes an API adapter interface 406, as discussed above. Also providing input and receiving feedback to student participant is the prompting or text-to-speech interface 410. Modules 406 and 410 are both driven by tutoring engine 412. In this embodiment, to the engine 406 provides the intelligent analysis and decision-making involved in tutoring student by selecting content presentation strategies, learning style management strategies, and student mental state management strategies, for example. Tutoring engine 412 also employs a sequencing service 414 to sequence the presentation of various learning objects, or subjects within a particular learning object. Tutoring engine 412 also employs search/selection module 416 to aid in finding appropriate learning objects, reference material, or courseware, for example. Tutoring engine 412 further employees learning style analysis module 418 to perform the function of analyzing the learning style contained in learning objects or student-generated input. Learning objects may also include meta tags designating all or portions of the object as following or emphasizing a particular learning style. Tagging of learning content will be further discussed below.

Referring now to the asynchronous course interface 114 depicted in the lower portion of FIG. 4, the asynchronous courses interface has API 408 for providing service to the SCO API adapter running on the student machine 107. In a preferred embodiment, API 408 is a SCORM API, but other learning object interface games may be used.

By way of background, the typical SCORM API implementation (at the time of filing) exposes methods in three basic categories. Session methods are used to mark the beginning and end of a communication session between a SCO and a LMS through an instance of API 408. Data-Transfer methods are used to exchange data model values between a SCO and a LMS. Support methods are used for auxiliary communications like error handling between a SCO and a LMS.

In further detail, a Sharable Content Object (SCO) uses Session methods to initiate and terminate data communication between itself and a Learning Management System (LMS) via an Application Programming Interface (API) instance. Session methods are required for minimal Sharable Content Object Reference Model (SCORM) conformance to initialize when the SCO begins to run, and terminate when it exits. The SCO uses data-transfer methods to direct storage and retrieval of data to be used within the current communication session. The SCO uses such methods to transfer run-time data to and from the LMS. For example, the LMS can use this data to help determine completion of activities, for example, or to make sequencing and navigation decisions. Further, SCORM API Support methods allow an SCO to determine error handling and diagnostic information. Error conditions may occur in the various API functions. When such conditions are encountered, an error code is changed to indicate the error encountered. The support methods allow the SCO to determine if an error occurred and how to handle any such error.

As of the SCORM 2004 edition, the standard included three general specifications. A content aggregation model (CAM), a sequencing information and behavior specification (SN, “Sequencing and Navigation”), and a runtime environment specification (RTE). The CAM provides for the consistent labeling, packaging, storing, exchange and discovery of SCOs. A SCORM Content Package may represent a course, lesson, module or other group of related objects. Each SCO includes a manifest, analogous to a “packing slip,” that lists the contents of the SCO package and possibly a description of the content structure. The manifest may also include sequencing and navigation information. The SCORM Sequencing and Navigation (SN) specification defines a way to represent the intended behavior of a learning system such that a SCORM LMS will sequence learning activities consistently. The SN specification also defines the required functionality that SCORM LMSs must implement to process sequencing information at run-time. Specifically, it describes branching and flow of learning activities as an “Activity Tree,” which is based on the results of the learner's interaction with content objects combined with a predetermined sequencing strategy. The SCORM SN specification further describes how navigation events within a learning experience can be triggered and processed to identify (based on a strategy provided) learning activities for delivery. Typically, each learning activity identified for delivery will have an associated content object. The SCORM RTE specification describes how the LMS launches the content objects and manages the resulting learning experience. The RTE also describes the functionality of the SCORM API, that is, the use of SCOs as a standard communication mechanism. The SCORM 2004 standard, 3^{rd} Edition, is hereby incorporated by reference in its entirety for all purposes.

Referring again to FIG. 4, asynchronous courses interface 114 further includes a tracking service 420 that tracks the learner's progress through a structured set of course material, such as a learning tree including one or more learning objects. Tracking service 420 may receive input from API 408 and assessment service 424 concerning what material has been browsed, reviewed, what questions have been answered. Tracking service 420 may request data from content module 428 concerning whether a particular set of performance constitutes mastery of the subject matter. Tracking service 420 may store historical and performance data through the learner profile service 422. Course administration module 430 allows teachers or administrators access to change course settings and interact with the assessment service 424. Various learning objects and supporting multimedia data employed by system 400 may be stored in local databases 436, or maybe in remote repositories such as the depicted learning object/curriculum repository 432. System 400 may interface to remote repositories such as repository 432 through the open curriculum/curriculum server interface 132. In this embodiment, interface 434 may provide query services to facilitate searching by the tutoring engine 412, or by teachers, administrators, or students. The curriculum server interface 132 may also act as an agent to conduct financial transactions with remote repositories to obtain licenses and negotiate DRM terms concerning the desired learning objects. While the figure depicts only one remote repository 432, more than one repository may be accessed.

The lower depicted delivery module 426 is, in a preferred embodiment, a collection of web server services delivering pages produced through PHP, and various multimedia and interactive plugins. While PHP is preferred in one embodiment, other architectures may of course be used. Further while a server-based LMS is described herein as one embodiment, a standalone LMS or an off-line learning hybrid system may be used.

FIG. 5 is a flow chart of one tutoring method for an intelligent tutor application according to one embodiment.

By way of background, cognitive and educational researchers have identified various learning styles, categorized in several ways. One popular theory recognizes three learning styles: Visual, Auditory, and Kinesthetic (Also knows as VAK). Another taxonomy, the Felder-Solomon system, assesses the student's acuity in these four areas: Visual-verbal learning; Active-reflective learning; Sensing-intuitive learning; and Sequential-global learning. Another approach is to identify intelligences or abilities of the brain. One researcher, Howard Gardner, identified seven or eight different ways to demonstrate intelligence. Gardner defined intelligence as the ability to solve problems, the ability create new problems to solve, and the ability to produce something of value in your culture. Gardner's original seven identified intelligences are as follows:

Linguistic—words and language

Logical-Mathematical—logic and numbers

Musical—music, sound, rhythm

Bodily-Kinesthetic—body movement control

Spatial-Visual—images and space

Interpersonal—other people's feelings

Intrapersonal—self-awareness.

Others have suggested augmenting this list with further intelligences such as a ‘naturalist’ intelligence. Various pedagogical methods have been and will be developed employing selected learning style application in teaching. In particular, the VAK taxonomy is popular because of its simplicity and usefulness. Preferred intelligent tutor applications employ learning-style adaptive techniques.

Referring to FIG. 5, in this embodiment, in the step 502 an intelligent tutoring application may start a tutoring session with the selection of the current course in which a student desires or is scheduled to work, in which lesson or object is presently needed to progress. In step 504, the tutor application selects a currently preferred learning style or learning intelligence, in which lesson data and preferably be framed to best present lessons to the student. For example the auditory learning style may be employed. Learning styles will be further discussed below.

Next in step 506, the tutor presents the selected core material in the learning object. If educational content is not available for a particular concept in the desired learning style, in step 506 the tutor application may perform a search of local or remote learning object repositories. An assessment is provided over the presented material instead 508. At the assessment determines that the concepts were understood adequately, the tutor application continues to step 512. If the assessment in step 508 shows an adequate understanding, the tutor application may proceed to step 511 and perform remediation steps or learning state adjustment routines. Learning state adjustment will be further discussed below. Further, while the depicted chart shows a presentation of material followed by an assessment, this is not limiting and materials may be interspersed with assessments according to various known pedagogical techniques associated with e-learning.

After a successful assessment in step 510, a tutor application may proceed, in this embodiment, to assess the students comprehension or facility on the presented core subject matter and other learning styles or “multiple intelligences”. For example, if a student is determined primarily to be a visual style learner, the first presentation of the core material in step 506 may be through content designed in a primarily visual style. In this example, the second assessment in step 512 may assess other learning styles such as, for example, auditory or kinesthetic. This step seeks to determine if a student is comfortable dealing with material through other learning styles. If the assessment determines performance improvements can be made for performance at non-preferred styles (step 515), the tutor may proceed to present material authored in a blended manner combining material presented in the preferred learning style with material presented in the weak learning style.

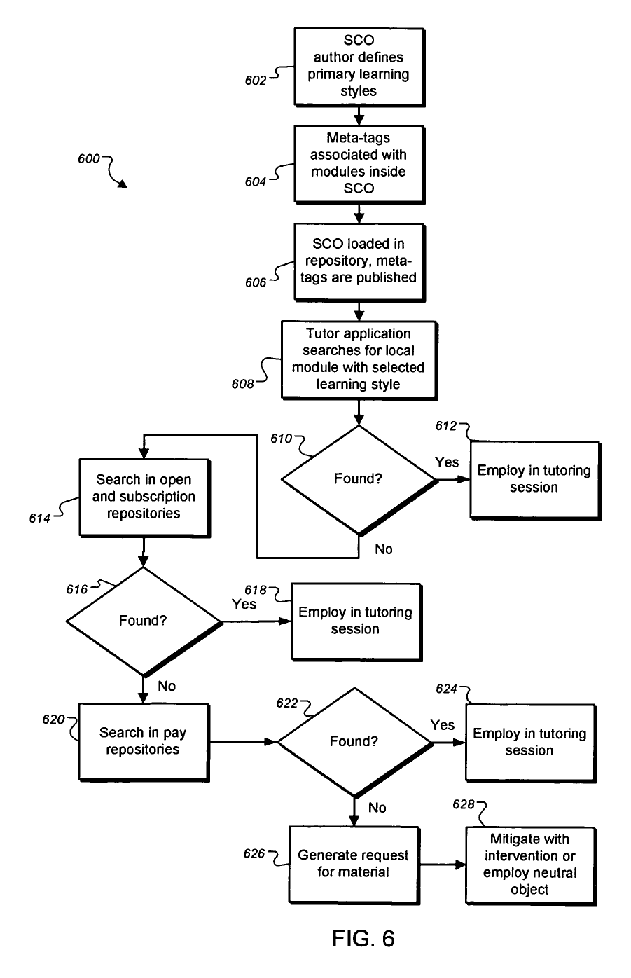

FIG. 6 is a flow chart of a learning object access method according to one embodiment. In the depicted embodiment, a learning object is generated by an author or system in step 602. The author of the learning object defines a primary learning style which the object is intended to implement, or in which the object is authored. One or more learning styles are preferably recorded as a property of the learning object. Preferably, this is accomplished using meta tags. In step 604, one or more meta tags is associated with each particular module inside the learning object to define the module's primary learning style. Other embodiments may also employ secondary learning style tags, for example, to identify material in which learning styles are blended. Various other tags may be employed to identify and enhance capabilities described herein, as will be apparent to a skill in the art upon appreciating the specification. For example, meta tags may identify a learning object as using a particular taxonomy of learning styles, such as the VAK taxonomy described above. Note that the meta tags associated in step 604 are not exclusive, and would typically be appended to other meta tag schemes that might be employed in a particular architecture. For example, such schemes would typically identify the grade level, subject, and type of learning object.

Some meta-tagging standards like the IMS Global Learning Consortium Learning Resource Meta-data Specification (IMS-LRM) or the Institute of Electrical and Electronics Engineers Learning Objects Metadata standards (IEEE LOM) provide specifications for tagging learning objects for more easily finding, accessing, publishing and reusing learning objects. The typical set of educational properties identified for a learning object in conformity with these two metadata standards would include the following properties:

5.1 interactivitytype Type of Interactivity

5.2 learningresourcetype Type of resource

5.3 interactivitylevel Level of Interactivity

5.4 semanticdensity Semantic Density

5.5 intendedenduserrole Intended for use by

5.6 context Intended for use in

5.7 typicalagerange Age or experience of intended user

5.8 difficulty Level of Difficulty

5.9 typicallearningtime Typical time required to complete

5.9.1 datetime Time 5.9.1

5.9.2 description Description

5.1 description How you can use this resource

5.11 language Language of intended user

These properties do not include a description of any targeted learning style of the content material. This may be because educators may try engage all learning styles or, in some cases, present learning-style neutral material. However, according to preferred embodiments herein, an LMS may present material targeted to different learning styles or combinations thereof in order to, for example, enhance an individual student's comprehension of the material, convey difficult material using preferred learning style, or improve the student's proficiency and a non-preferred learning style.

In step 606, the tagged a learning object is published in a database or repository such as database 436 or repository 432 (FIG. 4). Next, in step 608, a tutor application conducting or planning a lesson searches the database or repository for a learning module having the selected learning style. Of course, more search parameters are employed then merely a learning style. The subject, level, and topic or lesson would typically be employed, for example. The techniques taught herein may be employed within a wide variety of pedagogical classification methods and are therefore not limited by such.

If any suitable or matching object is found in step 610, the object is employed in the desired tutoring session in step 612. A suitable object may be one that matches within a certain margin of error, and certain applications may not require an exact match of certain search parameters. If no matching object is found in step 610, the tutor application proceeds to search in the available open or free repositories and in those repositories were which the tutor has access through a paid-up subscription. If the matching object is found for this search in step 616, the object is employed in a tutoring session in step 618. If no suitable object is found in step 616, computer application proceeds to search in pay repositories such as repositories that may require a per object payment or per use payment.

If a suitable object is found in step 622, the object is employed in a tutoring session in step 624. If no suitable object is found result from the search in step 622, the tutor application has exhausted its search options and must enter a request for the system administrators or curriculum maintainers to provide such an object in step 626. If the search is conducted in context of an ongoing or real time tutoring session, the tutor application must of course continue with the session and would therefore mitigate the lack of an appropriate object with either intervention by a live teacher or they use of a learning-style-neutral object in place of the desired learning-style-specific object.

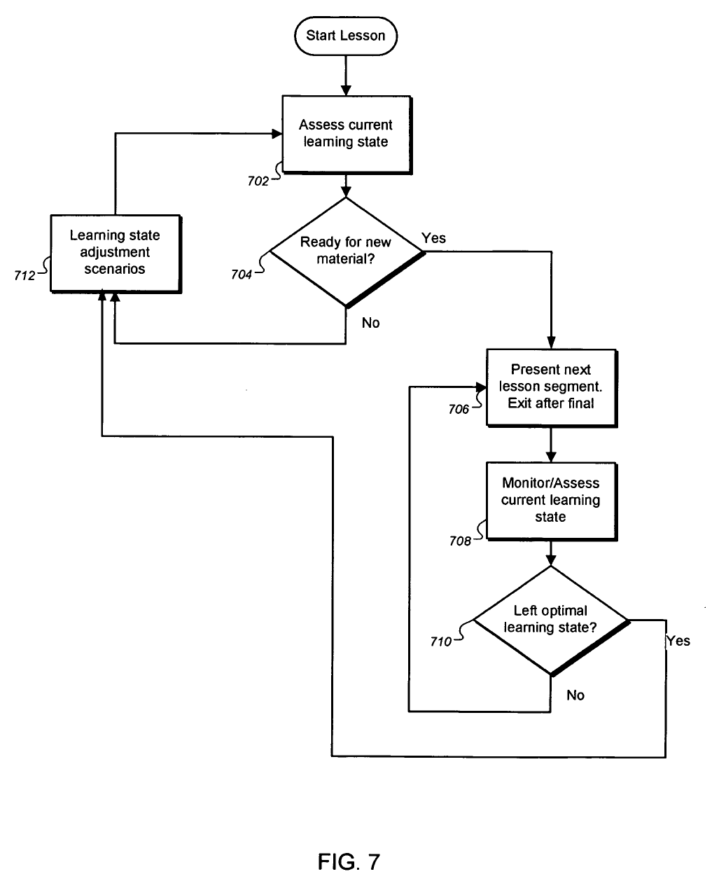

As will be understood by those of skill in the art, particular applications may require certification of learning objects or a quality check thereof. It is assumed that the tutoring application searches only for appropriately qualified objects. In some embodiments, upon exhausting a search for qualified or certified objects, a tutor application may search for other objects such as, for example, those that have not been certified for its particular home state, or in open source or creative commons style of object. In such case, an object may be reviewed and appropriateness by an intervening content administrator before use. FIG. 7 is a flow chart of a learning state adjustment method according to one embodiment. In this embodiment, an intelligent tutor application uses adaptive methods to track and enhance the students learning state.

By way of background, education researchers in the late 90s explored the relationship between the emotional state of students and their ability to learn. For example, Caine and Caine taught that an emotional state of threat, distress, or perceived threat has a detrimental effect on the learning functions of the brain. A relaxed emotional state has a positive effect. However the interest level, or mount a challenge, and a student's emotional state was just the opposite. A feeling of low challenge was associated more learning, while one of high challenge was associated with optimal learning. Caine and Caine concluded that an optimal learning state would be a relaxed and challenged state. Other educational researchers the reached slightly different conclusions, but there is consensus that, for particular student, an optimal emotional state for learning may be reached. That is not to say that the student should always operate in such a state. For example, removing all emotional threats from a learning environment may hamper students ability to deal with such emotion threats. That being said, an intelligent tutor application may monitor and adjust a student's emotional state to maintain a certain designated optimal combination of characteristics such as, for example, relaxation and alertness. Of course, adjustment may only be made to those environmental parameters within the influence of the tutor application. For example, a rigorous timed evaluation or some material presented in a nonpreferred learning style the affected students feeling of threat or of challenge.

The flow chart in FIG. 7 shows a method which may be employed in the presentation of less material to a student. As a lesson starts, the tutor assesses the students current learning state in step 702. This may be done by questioning the student, measuring responses to different stimuli, or any other way by which an emotional state may be observed. If the student's emotional state (learning state) is that are near its designated optimal point, student is ready for new material to be presented in step 704. If not, from step 704 method proceeds to execute one or more learning state adjustments scenarios in step 712. After that the assessment process in step 702 repeats.

A successful assessment proceeds to step 706, where the tutor application presents the next scheduled or chosen segment of the present lesson to the student. As the learning material presentation continues, tutor application they also continue to monitor or access the students current learning state in step 708. If the application determines the student has left an optimal learning state, in step 710, the method proceeds to the learning state adjustments scenarios in step 712.

Such learning state or emotional state adjustments scenarios may include, for example, presenting easier material, presenting material with which students already familiar, or switching the lesson to a topic the student has mastered or has a history of dealing with in a stable and optimal emotional state. The application may store with the tracking service 420 or learning profile service 422 a sequenced record the student's emotional state when dealing with each lesson or lesson segment. In preferred embodiment, such data is stored in an XML tag format along with the other results of the particular lesson segment.

Further, in a preferred embodiment, learning objects may have segments or material in a particular lesson authored in such a way is to reduce the perceived threat. For example, a lesson include an alternate presentation of a particular concept with a non-threatening narrator or presented in a friendly, un-timed, and step-by-step fashion.

A number of embodiments of the invention have been described. Nevertheless, it will be understood that various modifications may be made without departing from the spirit and scope of the invention. Accordingly, other variations are within the scope of the following claims.

What is claimed is:

1. A learning management system comprising:
a learning management system server hosting a software interface exposing functions to process learning activities associated with conformant learning objects presented at a participant client application having a first software interface adapter;
an intelligent tutor application for selecting and providing learning objects for presentation to a participant through the participant client application, the intelligent tutor application comprising a second software interface adapter for sending software interface function commands associated with the conformant learning object on behalf of the participant, the intelligent tutor application further comprising a search and selection software module, a learning style analysis software module, and a tutoring engine software module.

2. The system of claim 1 wherein the learning management system server further comprises an interface to local databases holding a first set of learning objects.

3. The system of claim 2 wherein the learning management system server further comprises an interface to at least one remote database holding a second set of learning objects.

4. The system of claim 1 wherein the learning management system server further comprises a learner profile service software module for tracking a learners preferred and non-preferred learning styles.

5. The system of claim 1 wherein the software interface on the learning management system server is an API capable of interfacing with the first software interface adapter and second software interface adapters, which are both API adapters.

6. The system of claim 5 in which the API is a SCORM API.

7. The system of claim 6 in which the first software interface adapter is a SCORM API adapter, and the second software interface adapter is an augmented SCORM API adapter.

8. A method of presenting a computer-assisted tutoring session, the method comprising:
searching, by a tutor application, for a first learning object having a first subject characteristic and a first preferred learning style characteristic;
presenting the first learning object to a student having a profile indicating the first preferred learning style characteristic.

9. The method of claim 8 further comprising assessing the student's facility for working with a second learning style with material taught from the first learning object.

10. The method of claim 9 wherein the second learning style is a non-preferred learning style indicated in the student's profile.

11. The method of claim 10 further comprising searching, by the tutor application, for a second learning object having a third blended learning style of the second learning style and the first learning style.

12. The method of claim 11 further comprising presenting the second learning object to the student, the second learning object including a material in the first preferred learning style and the second non-preferred learning style.

13. The method of claim 11 wherein the second learning object has associated meta tags indicating a mixed learning style of the first preferred learning style and the second non-preferred learning style.

14. The method of claim 8 wherein the first learning object has an associated meta-tag indicating a primary learning style, and the tutor applications searching process includes searching for a matching meta-tag.

15. A learning management system comprising:
a learning management system server hosting a software interface exposing functions to process learning activities associated with conformant learning objects presented at a participant client application having a first software interface adapter;
an intelligent tutor application, running on the learning management system server, for selecting and providing learning objects for presentation to a participant through the participant client application, the intelligent tutor application further comprising a search and selection software module operable to search a first local learning object repository and at least a second remote learning object repository.

16. The system of claim 15 wherein the learning management system server further comprises an identifier key for a subscription to the second remote learning object repository.

17. The system of claim 16 wherein the intelligent tutor application is programmed to minimize cost of providing a suitable learning object needed for provision to a participant by first selecting local repository learning objects, and lacking those selecting flat rate subscription learning objects, and lacking those selecting pay-per-use learning objects.

18. The system of claim 15 wherein the search and selection software module is operable to search meta-tags associated with learning objects.

19. The system of claim 18 wherein the meta-tags provide at least one indication of learning style characteristics of their associated learning objects.

20. The system of claim 19 wherein the meta-tags provide an indication of a primary learning style and a secondary learning style associated with a single learning object.
